(19) United States
(12) Patent Application Publication
(10) Pub. No.: US 2024/0083445 A1
(43) Pub. Date: Mar. 14, 2024

(54) CONTROL DEVICE, CONTROL METHOD, AND NON-TRANSITORY COMPUTER READABLE STORAGE MEDIUM

(71) Applicant: DENSO CORPORATION, Kariya-city (JP)

(72) Inventor: ITSUKI CHIBA, Kariya-city (JP)

(21) Appl. No.: 18/513,010

(22) Filed: Nov. 17, 2023

Related U.S. Application Data
(63) Continuation of application No. PCT/JP2022/012927, filed on Mar. 21, 2022.

(30) Foreign Application Priority Data
May 21, 2021 (JP) 2021-086361

(51) Int. Cl. B60W 50/00; B60W 60/00

(52) U.S. Cl. CPC B60W 50/00; B60W 60/001; B60W 2050/0095; B60W 2555/20; B60W 2555/60

(57) ABSTRACT

An autonomous driving ECU as a control device includes a processor. The processor executes: acquiring sensor information as a detection result regarding a detection target existing in an outside a vehicle by a periphery monitoring sensor mounted on the vehicle; acquiring communication information regarding the detection target received from an external device of the vehicle; evaluating detection quality in the sensor information and the communication information; and changing an operation mode of the application in response to the detection quality.

### CROSS REFERENCE TO RELATED APPLICATIONS

The present application is a continuation application of International Patent Application No. PCT/JP2022/012927 filed on Mar. 21 2022, which designated the U.S. and claims the benefit of priority from Japanese Patent Application No. 2021-086361 filed on May 21, 2021. The entire disclosures of all of the above applications are incorporated herein by reference.

### TECHNICAL FIELD

The disclosure in this specification relates to a technique for controlling execution of an application for a vehicle.

### BACKGROUND

A conceivable technique teaches a technique of using both map information acquired through communication and information detected by an in-vehicle sensor. In this technique, the distance measured by the in-vehicle sensor is corrected based on the error between the known distance between two points based on map information and the distance measured by the in-vehicle sensor.

### SUMMARY

According to an example, an autonomous driving ECU as a control device includes a processor. The processor may execute: acquiring sensor information as a detection result regarding a detection target existing in an outside a vehicle by a periphery monitoring sensor mounted on the vehicle; acquiring communication information regarding the detection target received from an external device of the vehicle; evaluating detection quality in the sensor information and the communication information; and changing an operation mode of the application in response to the detection quality.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram showing an entire system including a control device;

FIG. 2 is a block diagram showing an overall configuration of a vehicle;

FIG. 3 is a block diagram showing one example of a function in an autonomous driving ECU;

FIG. 4 is a diagram showing a table of an example of evaluation of communication information and sensor information and an application mode; and

FIG. 5 is a flowchart showing one example of a control method executed by the autonomous driving ECU.

### DETAILED DESCRIPTION

The conceivable technique merely corrects detection information using the map information. The conceivable technique does not teach a method for effectively utilizing information acquired by communication and information acquired by an in-vehicle sensor.

According to present embodiments, a control device, a control method, and a control program are provided that can effectively utilize information.

The aspects in the present embodiments employ different technical means to attain the respective objectives. It is to be noted that reference numerals in parentheses described in this section and the scope of the claims are examples indicating correspondences with specific means described in embodiments described later as one embodiment and do not limit the technical scope.

One of control devices according to the present embodiments is a control device that includes a processor and controls an application running based on detection results regarding events outside the vehicle.

The processor is configured to execute:
acquiring sensor information, which is a detection result of an autonomous sensor mounted on the vehicle;
acquiring communication information that is a detection result received from an external device of the vehicle;
evaluating detection quality in the sensor information and the communication information; and
changing an operation mode of the application according to the detection quality.

One of control methods according to the present embodiments is a control method that is executed by a processor to control an application running based on detection results regarding events outside the vehicle.

The control method includes:
acquiring sensor information, which is a detection result of an autonomous sensor mounted on the vehicle;
acquiring communication information that is a detection result received from an external device of the vehicle;
evaluating detection quality in the sensor information and the communication information; and
changing an operation mode of the application according to the detection quality.

One of control programs according to the present embodiments is a control program that includes instructions to be executed by a processor to control an application running based on detection results regarding events outside the vehicle.

The instructions include:
acquiring sensor information, which is a detection result of an autonomous sensor mounted on the vehicle;
acquiring communication information that is a detection result received from an external device of the vehicle;
evaluating detection quality in the sensor information and the communication information; and
changing an operation mode of the application according to the detection quality.

According to these embodiments, the operation mode of the application that utilizes the communication information and the sensor information is changed based on evaluation of the communication information and sensor information. Therefore, the application can be executed in the operation mode according to the quality of the communication information and the sensor information. As described above, a control device, a control method, and a control program that can effectively utilize information can be provided.

### First Embodiment

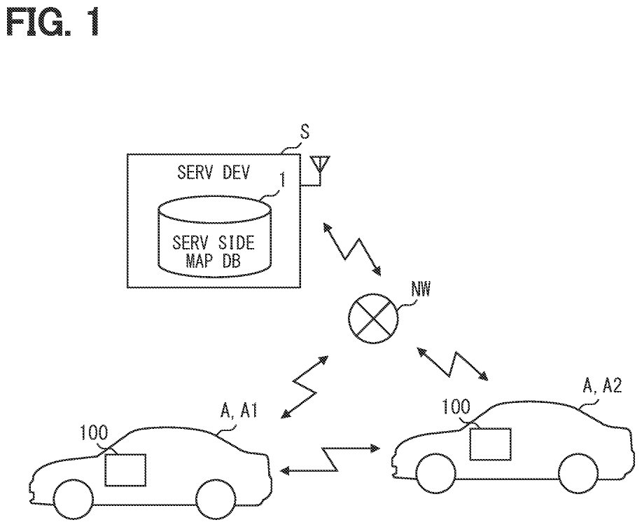

A control device according to a first embodiment will be described with reference to FIGS. 1 to 5. The control device in the first embodiment is provided by an autonomous driving ECU 100 mounted on a vehicle A such as a subject vehicle A1 and another vehicle A2. The autonomous driving ECU 100 is an electronic control unit that performs at least one of an autonomous driving function and an advanced driving assist function.

The autonomous driving ECU 100 can communicate with a server device S via the network NW. The server device S is an example of an external device disposed outside the vehicle A. The server device S has a server-side map DB1. The server side map DB 1 stores distribution source data of the map data to be stored in the vehicle side map DB 105, which will be described later. The server side map DB 1 comprehensively includes the map data of a wider area than the map data of the vehicle side map DB 105. The server side map DB 1 stores features such as road markings as data formed of a plurality of nodes including position information and a plurality of links including connection information between the nodes. In addition, the map data includes traffic control information by traffic lights installed at each intersection. Note that the map data may be appropriately updated based on detection data transmitted from the vehicle A.

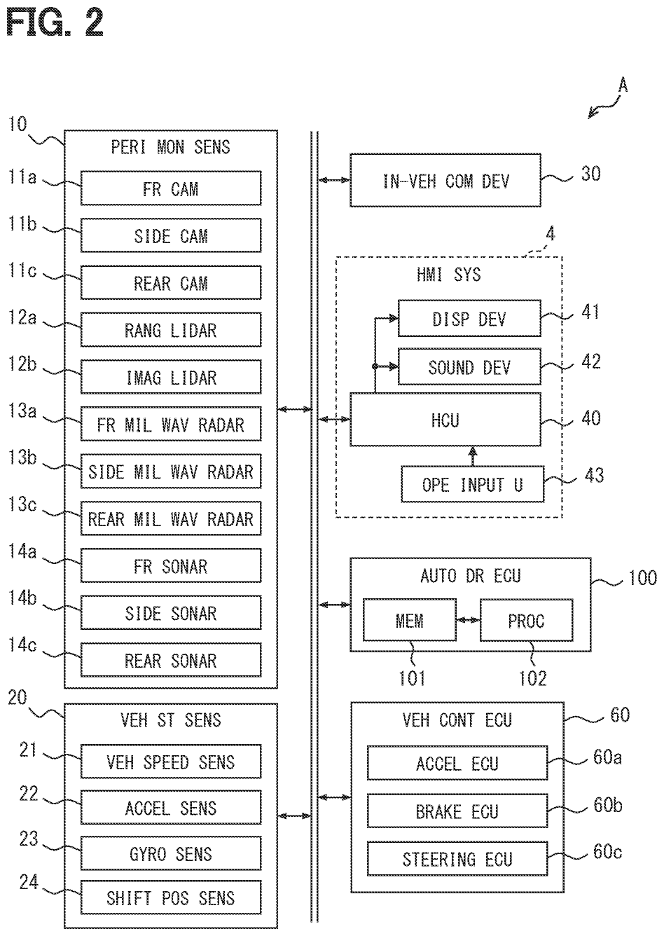

As shown in FIG. 2, the autonomous driving ECU 100 is connected to a periphery monitoring sensor 10 mounted in the vehicle A, a vehicle state sensor 20, an in-vehicle communication device 30, an HCU (i.e., Human Machine Interface Control Unit) 40, and a vehicle control ECU 60 via a communication bus or the like.

The periphery monitoring sensor 10 is an autonomous sensor group that monitors the external environment of the vehicle A. The periphery monitoring sensor 10 can detect the detection result regarding the external event of the vehicle A as sensor information. An event is an object or an event whose information is needed in the applications described below. The events include dynamic information and static information. The dynamic information is information that changes over time. It can also be said that the dynamic information is information that is more likely to change over time than the static information, which will be described later. The dynamic information is, for example, detection information about obstacles (e.g., animals, falling objects, and the like) disposed on the road, other vehicles A2, pedestrians, and other moving objects. The static information is information that is not changed over time. For example, the static information is detected information about substantially static features such as road markings, road signs, billboards, traffic lights, buildings, and the like.

The periphery monitoring sensor 10 includes at least one type of periphery monitoring cameras 11a, 11b, 11c, LiDAR (i.e., Light Detection and Ranging/Laser Imaging Detection and Ranging) 12a, 12b, millimeter wave radars 13a, 13b, 13c, and sonars 14a, 14b, 14c. The periphery monitoring cameras 11a, 11b, and 11c are imaging devices that capture a view of outside within a predetermined range. The periphery monitoring cameras 11a, 11b, and 11c include, for example, a front camera 11a having a imaging range in front of the vehicle A, a side camera 11b having an imaging range on a side of the vehicle A, and a rear camera 11c having an imaging range behind the vehicle A. It should be noted that a periphery monitoring camera capable of imaging a wider range covering the above-described imaging ranges may be used alternatively.

The LiDARs 12a and 12b detect a point group of characteristic points of a feature by emitting laser light and detecting light reflected by the feature. The LiDARs 12a, 12b include a ranging LiDAR 12a that measures a distance to an object reflecting the light and an imaging LiDAR 12b that can perform three-dimensional imaging of the object reflecting the light. A LiDAR having both functions of the LiDARs 12a and 12b may be used. The millimeter wave radars 13a, 13b, and 13c generate detection information of the surrounding environment by receiving reflection waves of emitted millimeter waves or quasi-millimeter waves. The millimeter-wave radars 13a, 13b, and 13c include, for example, a front millimeter-wave radar 13a having a detection range in front of the vehicle A, a side millimeter-wave radar 13b having a detection range on a side of the vehicle A, and a rear millimeter-wave radar 13c having a detection range behind the vehicle A. The sonars 14a, 14b, and 14c generate detection information of the surrounding environment by receiving reflected ultrasonic waves. The sonars 14a, 14b, 14c include a front sonar 14a, a side sonar 14b, and a rear sonar 14c each having a corresponding detection range, similar to the millimeter wave radars 13a, 13b, 13c. Note that the millimeter wave radar and sonar may each be capable of detecting a wider range covering the above-described detection ranges.

Each periphery monitoring sensor 10 sequentially outputs generated detection information to the autonomous driving ECU 100. By analyzing the detection information, each periphery monitoring sensor 10 recognizes the presence and the position of an obstacle on a traveling route and other vehicles A2 such as a preceding vehicle, a parallelly-traveling vehicle, and an oncoming vehicle.

The vehicle state sensor 20 is a sensor group for detecting various states of the vehicle A. The vehicle state sensor 20 includes, for example, a vehicle speed sensor 21, an acceleration sensor 22, a gyro sensor 23, and a shift position sensor 24. The vehicle speed sensor 21 detects a traveling speed of vehicle A. The acceleration sensor 22 detects acceleration acting on the vehicle A. The gyro sensor 23 detects an angular velocity acting on the vehicle A. The shift position sensor 24 detects the position of the shift lever of the vehicle A. The vehicle state sensor 20 may include a GNSS (i.e., Global Navigation Satellite System) receiver or the like that detects positioning signals from positioning satellites.

The in-vehicle communication device 30 is a communication module mounted in the vehicle A. The in-vehicle communication device 30 has at least a V2N (i.e., Vehicle to cellular Network) communication function conforming to communication standards such as LTE (i.e., Long Term Evolution) and 5G, and sends and receives radio waves to and from base stations around the vehicle A. The in-vehicle communication device 30 can communicate with the server device S of the center via the base station by the V2N communication. The in-vehicle communication device 30 may further have functions such as vehicle-to-road (i.e., Vehicle to roadside Infrastructure) communication and inter-vehicle (i.e., Vehicle to Vehicle) communication. The in-vehicle communication device 30 enables cooperation between a cloud system and an in-vehicle system (i.e., Cloud to Car cooperation) by the V2N communication. By mounting the in-vehicle communication device 30, the vehicle A as a connected car is able to connect to the Internet.

The in-vehicle communication device 30 can receive the communication information, which is the information about the detection target received from the external device of the vehicle A, by the above configuration. Here, the external device includes, for example, the server device S, the in-vehicle communication device 30 of the other vehicle A2, the roadside device, the communication terminal owned by the pedestrian, and the like.

The HCU 40 is one component of a HMI (i.e., Human Machine Interface) system 4. The HMI system 4 is a system for presenting information to occupants of the vehicle A, and includes a display device 41, a sound device 42, and an operation input unit 43 as components in addition to the HCU 40. The display device 41 is an in-vehicle display device mounted in the vehicle A. The display device 41 is, for example, a head-up display configured to project a virtual image onto a projection member, a meter display provided in the meter, or a CID (i.e., Center Information Display) provided in the center of the instrument panel. The sound device 42 is an audio output device such as a speaker mounted in the vehicle A. The operation input unit 43 is a device that receives an operation input from an occupant. The operation input unit 43 includes, for example, a touch panel installed on a display such as a CID, physical switches installed on a center console, a steering wheel, and the like.

The HCU 40 mainly includes a microcomputer equipped with a processor, a memory, an input/output interface, and a bus connecting these elements. The HCU 40 is electrically connected to the various devices described above and the autonomous driving ECU 100. The HCU 40 sequentially generates and outputs data to be presented to each device based on the data acquired from the autonomous driving ECU 100. Accordingly, the HCU 40 appropriately presents information to occupants including the driver.

The vehicle control ECU 60 is an electronic control device that performs acceleration and deceleration control and steering control of the vehicle A. The vehicle control ECU 60 includes an accelerator ECU 60a that performs acceleration control, a brake ECU 60b that performs deceleration control, a steering ECU 60c that performs steering control, and the like. The vehicle control ECU 60 acquires detection signals output from respective sensors such as the steering angle sensor, the vehicle speed sensor, and the like mounted in the vehicle A, and outputs a control signal to an electronic control throttle, a brake actuator, an EPS (i.e., Electronic Power Steering) motor, and the like. The vehicle control ECU 60 acquires a travel trajectory of the vehicle A during autonomous driving operation from the autonomous driving ECU 100, and controls each travel control device so as to realize driving assistance or autonomous traveling according to the travel trajectory.

The autonomous driving ECU 100 executes an advanced driving assistance function or an autonomous driving function based on information from the periphery monitoring sensor 10 and the vehicle state sensor 20 as described above. The autonomous driving ECU 100 mainly includes a memory 101, a processor 102, an input/output interface, a bus connecting these components, and the like. The processor 102 is a hardware for executing calculation processing. The processor 102 includes, as a core, at least one type of, for example, a CPU (i.e., Central Processing Unit), a GPU (i.e., Graphics Processing Unit), an RISC (i.e., Reduced Instruction Set Computer) CPU, and the like.

The memory 101 is at least one type of non-transitory tangible storage medium, such as a semiconductor memory, a magnetic storage medium, and an optical storage medium, for non-transitory storing or memorizing computer readable programs and data. The memory 101 stores various programs executed by the processor 102, such as a autonomous driving control program which will be described later. In addition, the memory 101 stores a vehicle side map database (hereinafter, referred to as “DB”) 105.

The vehicle side map DB 105 stores map data such as link data, node data, road shape, structures and the like. For example, the vehicle-side map DB 105 stores features such as lane markings, road markings, road signs, and road structures as data including multiple nodes with location information and multiple links with connection information between nodes. Such information is the static information. The map data may include a three-dimensional map including point groups of feature points of features, road shapes, and buildings. The three-dimensional map may be generated based on a captured image by REM (i.e., Road Experience Management, REM is a registered trademark). The map data may include dynamic information such as information on areas with an accident risk, information on accidents that has occurred along the travelling route, information on falling objects, and the like. The data stored in the vehicle-side map DB 105 is appropriately updated based on information transmitted from the server device S periodically or as needed.

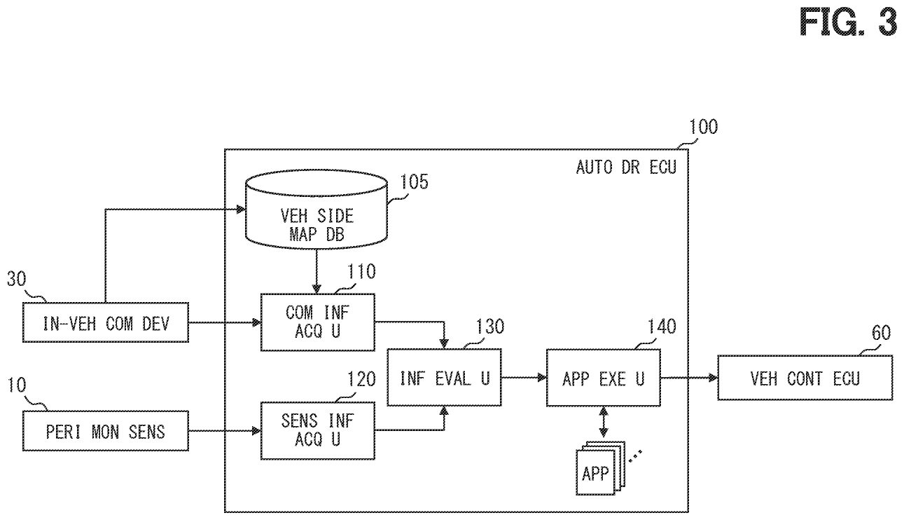

The processor 102 executes multiple instructions included in the autonomous driving control program stored in the memory 101. Thereby, the autonomous driving ECU 100 provides a plurality of functional units for executing the advanced-driving assistance function or the autonomous driving function. Specifically, functional units such as a communication information acquisition unit 110, a sensor information acquisition unit 120, an information evaluation unit 130, and an application execution unit 140 are established in the autonomous driving ECU 100, as shown in FIG. 3.

The communication information acquisition unit 110 acquires communication information received by the in-vehicle communication device 30. The communication information acquisition unit 110 may acquire the communication information directly from the in-vehicle communication device 30, or may acquire the communication information from a storage medium such as the vehicle-side map DB 105 in which the communication information is stored.

The sensor information acquisition unit 120 acquires sensor information detected by the periphery monitoring sensor 10. The sensor information acquisition unit 120 may acquire sensor information directly from the periphery monitoring sensor 10, or may acquire sensor information from a storage medium storing the sensor information.

The information evaluation unit 130 calculates an evaluation regarding the detection quality of the communication information and the sensor information. Here, the detection quality is a parameter that serves as an indicator of the usefulness of the information when it is assumed that it will be used in an application. Specifically, the information evaluation unit 130 evaluates the response margin, freshness, and accuracy for each piece of information.

The response margin is a parameter that indicates the amount of margin in time or distance from when the information is acquired until specific processing is executed based on the information. For example, in the case of map data, the map data relating to an area farther from the current position of the vehicle A has a greater degree of the response margin. Further, in the case of detection information relating to an object, the detection information relating to an object at a position farther from the current position of the vehicle A has a greater degree of the response margin.

The freshness is a parameter indicating newness of information. For example, in the case of map data, the freshness is determined based on the period until the next update, the presence or absence of construction information that accompanies road shape changes, the frequency of changes due to previous updates, and the like. The freshness of the map data reflects the latest information. Further, in the case of detection information about an object, the freshness of the detection information is considered to be newer as the detection time of the object is newer.

The accuracy is a parameter that indicates the degree of certainty of information. Specifically, the accuracy is an index that indicates how close information is to the true value. The closer the information is to the true value, the higher the accuracy. For the static information about the same event, the communication information has a relatively higher accuracy than the sensor information. In the case of the dynamic information about the same event, the possible accuracy range of the communication information covers the possible accuracy range of the sensor information.

The information evaluation unit 130 evaluates each parameter as a plurality of levels. For example, the response margin is evaluated as “long” and “short”, the freshness is evaluated as “new” and “old”, and the accuracy is evaluated as “high” and “low”. Note that the threshold for selecting the level may be changed according to the type of the communication information and the sensor information, the type of application using the communication information, and the like.

A “long” response margin is an example of “within the allowable margin”, and a “short” response margin is an example of “outside the allowable margin”. In addition, being “new” is an example of being “within the allowable freshness range”, and being “old” is an example of being “outside the allowable freshness range”. Furthermore, being “high” is an example of being “within the allowable accuracy range”, and being “low” is an example of being “outside the allowable accuracy range”.

The information evaluation unit 130 appropriately provides evaluations of the above parameters to the application execution unit 140. Further, when there is a parameter that cannot be evaluated, the information evaluation unit 130 also provides the information indicating that the parameter cannot be evaluated to the application execution unit 140. For example, if there is no data regarding a specific detection target in the map data, the information evaluation unit 130 determines that at least the accuracy of the map data (i.e., communication information) regarding the detection target cannot be evaluated. If the communication information related to the detection target fails to be received or the reception delay is unacceptably large, the information evaluation unit 130 determines that at least the accuracy of the communication information related to the detection target cannot be evaluated. Further, when a failure occurs in the periphery monitoring sensor 10 or when a communication anomaly occurs between the periphery monitoring sensor 10 and the autonomous driving ECU 100, the information evaluation unit 130 determines that at least the accuracy of the sensor information detected by the sensor cannot be evaluated. The presence of such information whose accuracy cannot be evaluated can be rephrased as the failure of the information.

The application execution unit 140 executes one or more applications. The applications utilize the communication information and the sensor information to perform specific operations. As an example, the application performs a processing related to safety functions that reduce risks while driving. Specifically, a pre-collision safety (i.e., PCS, Pre-Collision Safety) function, an automatic emergency braking (i.e., AEB, Automatic Emergency Braking) function, and the like are realized by corresponding applications. Furthermore, an adaptive cruise control (i.e., ACC, Adaptive Cruise Control) function, a lane keeping assist (i.e., LKA, Lane Keeping Assist) function, and the like may be realized. In addition, an urban road speed management (i.e., URSM, Urban Road Speed Management) function may be realized that performs notification and speed control according to the speed limit of the road on which the vehicle is traveling, and travelling control according to traffic lights. Based on the communication information and the sensor information, the application determines whether or not one or more operation start conditions are satisfied, and starts the corresponding process when it is determined that the conditions are satisfied. Specifically, a control command for the travel control device is generated and transmitted to the vehicle control ECU 60.

The application execution unit 140 changes the operation mode of the application according to the evaluation of the communication information and the sensor information. The operation mode of the application includes at least one of whether or not the communication information and the sensor information are used, whether or not recognition preparation is performed, and whether or not application preliminary preparation is performed.

The recognition preparation is preparation processing for future external environment recognition by the periphery monitoring sensor 10, that is, acquisition of the sensor information. For example, the recognition preparation is processing for estimating the existence range of a detection target based on the communication information.

The application preliminary preparation is preparation processing related to execution of functions of the application. For example, the application preliminary preparation is at least one of a preparation process (i.e., a start preparation process) for satisfying the operation start condition of the application and a preparation process (i.e., an effect preparation process) for enhancing the operation effect. The start preparation process includes, for example, lowering the threshold value of the operation start conditions, omitting at least one or more of the operation start conditions, and the like. The effect preparation process includes, for example, increasing the responsiveness of the vehicle A with respect to the travel control. The processing to improve responsiveness includes, for example, processing to increase steering responsiveness and braking force by increasing the damping force of the suspension, processing to speed up the start of deceleration with the brake by applying hydraulic pressure enough to fill the gap between the brake pad and the rotor.

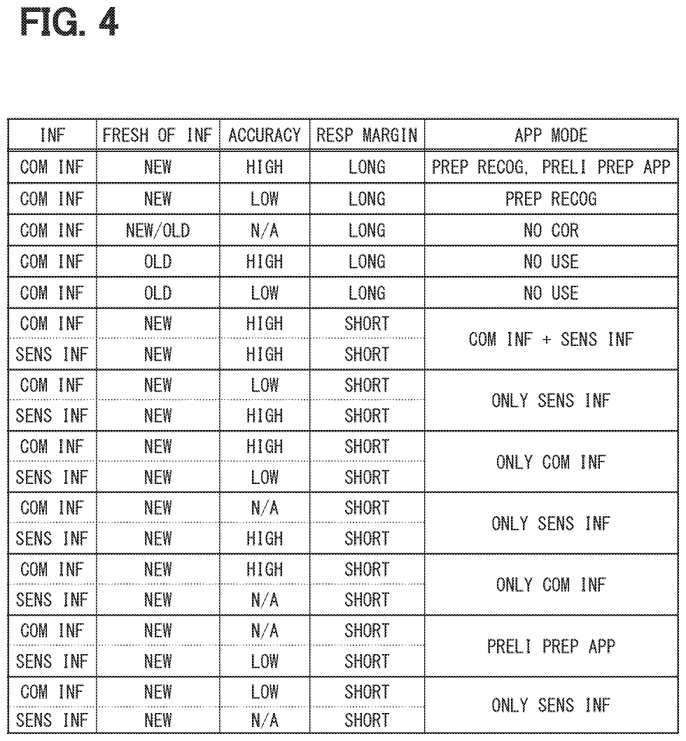

Determination of the application mode based on the evaluation result of each parameter will be described with reference to the table in FIG. 4.

First, when the response margin of the communication information is long, the application execution unit 140 determines an application mode using only the communication information among evaluation parameters of the communication information and the sensor information.

Then, when the freshness of the communication information is new and the accuracy is high, the application execution unit 140 executes the recognition preparation and the application preliminary preparation as application modes. On the other hand, when the freshness of the communication information is old and the accuracy is high, the application execution unit 140 executes the recognition preparation as an application mode and does not execute the application preliminary preparation.

Further, when the accuracy of the communication information cannot be evaluated (see “N/A”, i.e., not-applicable in the table), the application execution unit 140 sets the application mode to not-applicable regardless of the freshness.

Furthermore, when the freshness of the communication information is old, the application execution unit 140 sets the application mode to no use of the communication information regardless of whether the accuracy is high or low.

Then, when the communication information response margin is short, the application execution unit 140 determines the application mode based on the accuracy of each of the communication information and the sensor information. Here, it is assumed that the sensor information basically has a short response margin. Also, in the example shown in FIG. 4, it is assumed that the communication information obtained by the V2X communication is acquired as the communication information with a short response margin. It is assumed that both the communication information and the sensor information in this example have new freshness.

Under these conditions, when the accuracy of both communication information and the sensor information is high, the application execution unit 140 determines an application mode that uses both information. Then, when the accuracy of one of the accuracy of the communication information and the sensor information is low and the accuracy of the other is high, the application execution unit 140 uses the information with the higher accuracy and does not use the information with the lower accuracy. Furthermore, when one accuracy is high and the other accuracy cannot be evaluated, the application execution unit 140 uses the information with the higher accuracy and sets the application mode of the information without accuracy information to no use.

Further, when the accuracy of the communication information cannot be evaluated and the accuracy of the sensor information is low, the application execution unit 140 determines execution of the application preliminary preparation as an application mode. On the other hand, when the accuracy of the communication information is low and the accuracy of the sensor information cannot be evaluated, the application execution unit 140 uses the sensor information and sets the application mode of the communication information to no use.

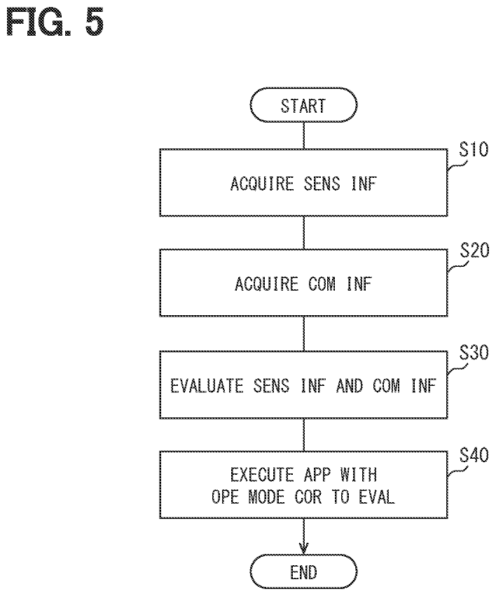

Next, the flow of the control method executed by the ECU 100 in cooperation with the functional blocks will be described below with reference to FIG. 5. In a flowchart to be described later, “S” means multiple steps of the flowchart to be executed by multiple instructions included in the program.

First, in S10, the sensor information acquisition unit 120 acquires the sensor information. Next, in S20, the communication information acquisition unit 110 acquires the communication information. In continuing S30, the information evaluation unit 130 evaluates the communication information and the sensor information. Furthermore, in S40, the application execution unit 140 determines an operation mode according to the evaluation and executes the application.

According to the first embodiment described above, the operation mode of the application is changed based on the evaluation of communication information and the sensor information. Therefore, the application can be executed in the operation mode according to the detection quality of the communication information and the sensor information. As described above, information can be effectively utilized in the control device.

Further, changing the operation mode includes determining the operation mode based on the evaluation of the communication information regardless of the evaluation of the sensor information when the response margin of the communication information is disposed within the allowable margin range. According to this, when the response margin of the communication information is relatively long, the operation mode can be changed regardless of the evaluation result of the sensor information with the relatively short response margin.

Further, changing the operation mode includes changing to an operation mode that does not use the communication information when the response margin of the communication information is disposed within the allowable margin range and the freshness is disposed outside the allowable freshness range. According to this, since the communication information whose freshness is out of the allowable freshness range is not used, malfunction of the application due to the use of inaccurate communication information can be suppressed.

In addition, changing the operation mode includes preparation for future recognition of the external environment of the vehicle A by the periphery monitoring sensor 10 when the communication information response margin is disposed within the allowable margin range and the freshness is disposed within the allowable freshness range. According to this, preparation for external environment recognition based on the communication information whose freshness is disposed within the allowable freshness range can be executed. Therefore, the process for acquiring the future sensor information can be simplified.

Further, changing the operation mode includes preliminary preparation relating to the execution of the function in the application when the response margin of the communication information is disposed within the allowable margin range, the freshness is disposed within the allowable freshness range, and the accuracy is disposed within the allowable accuracy range. According to this, the application can operate smoothly based on the communication information with relatively high reliability.

Furthermore, changing the operation mode includes stopping the use of one of or both of the communication information and the sensor information whose accuracy is disposed outside the allowable accuracy range when the response margin of the communication information is disposed outside the allowable margin range. According to this, only the information whose accuracy is disposed within the allowable accuracy range can be selectively used among the information with a short response margin. Therefore, the certainty of operation of the application can be improved.

In addition, changing the operation mode includes preliminary preparation relating to the execution of the function in the application when the response margin of the communication information is disposed outside the allowable margin range, the accuracy of the communication information cannot be evaluated, and the accuracy of the sensor information is disposed outside the allowable accuracy range. According to this, the application can operate smoothly even when the accuracy of the sensor information changes to be disposed within the allowable accuracy range so that the sensor information becomes available, and the application operates based on the sensor information.

### Second Embodiment

In a second embodiment, a modification example of the autonomous driving ECU 100 described in the first embodiment will be described. In the second embodiment, the application executing unit 140 further considers whether the sensor information and the communication information are static information or dynamic information in S40 to determine the operation mode of the application.

An example of operation mode determination according to evaluation of the sensor information and the communication information as the static information will be described below. If both the sensor information and the communication information are not defective, the application execution unit 140 determines an operation mode in which the sensor information is supplemented with the communication information to utilize. For example, when the accuracy of the sensor information is less than or equal to the threshold, the application execution unit 140 supplements the information regarding the detection target with the corresponding communication information. Alternatively, the application execution unit 140 supplements with the communication information even when the sensor information response margin is equal to or less than the threshold value. In this case, the application execution unit 140 also determines execution of application preliminary preparation using the map information in the communication information.

Then, when the sensor information is acquired and the communication information is defective, the application execution unit 140 sets an operation mode in which only the sensor information is used.

Further, when the communication information is acquired and the sensor information is defective when the vehicle A is activated, the application execution unit 140 may set an operation mode in which the communication information is not used. Further, when the communication information is acquired and the sensor information is defective while the vehicle A is running, the application execution unit 140 sets a specific condition regarding the utilization of the communication information. The application execution unit 140 permits the use of the communication information when the condition is met, and does not permit the use of the communication information when the condition is not met.

For example, the condition includes at least one of: a condition such that the present position can be estimated until just before the sensor information is not acquired, a condition such that the gradient change of the road around the present position is less than or equal to the threshold, a condition such that the curvature of the road in the travelling direction is greater than or equal to the threshold, a condition such that weather is not bad weather such as snowfall or rain, a condition such that the vehicle speed is less than or equal to a threshold, and a condition such that the freshness of the communication information is greater than or equal to a threshold.

An example of operation mode determination according to evaluation of the sensor information and the communication information as the dynamic information will be described below. If both the sensor information and the communication information are not defective, the application execution unit 140 determines an operation mode in which the sensor information and the communication information are supplemented with each other to utilize. In this case, the application execution unit 140 also determines execution of the application preliminary preparation as one of the operation modes.

Then, when the sensor information is acquired and the communication information is defective, the application execution unit 140 sets an operation mode in which only the sensor information is used.

Further, when the communication information is acquired and the sensor information is not acquired when the vehicle A is activated, the application execution unit 140 may set an operation mode in which the communication information is not used. In this case, the application execution unit 140 also determines execution of the application preliminary preparation as one of the operation modes.

### Other Embodiments

The disclosure in the present specification is not limited to the above-described embodiments. The present disclosure includes embodiments described above and modifications of the above-described embodiments made by a person skilled in the art. For example, the present disclosure is not limited to a combination of the components and/or elements described in the embodiments. The present disclosure may be executed by various different combinations. The present disclosure may include additional configuration that can be added to the above-described embodiments. The present disclosure also includes modifications which include partial components/elements of the above-described embodiments. The present disclosure includes replacements of components and/or elements between one embodiment and another embodiment, or combinations of components and/or elements between one embodiment and another embodiment The disclosed technical scope is not limited to the description of the embodiment. Several technical scopes disclosed herein are indicated by descriptions in the claims and should be understood to include all modifications within the meaning and scope equivalent to the descriptions in the claims.

In the above-described embodiment, the dedicated computer that constitutes the control device provides the autonomous driving ECU 100. Alternatively, the dedicated computer that constitutes the control device may be the vehicle control ECU 60 mounted on the vehicle A, or may be an actuator ECU that individually controls the traveling actuators of the vehicle A. Alternatively, the dedicated computer that constitutes the control device may be a navigation ECU. Alternatively, the dedicated computer that constitutes the control device may be the HCU 40 that controls the information display of the information display system. Also, the dedicated computer that constitutes the control device may be a server device provided outside the vehicle A.

The control device may be a special purpose computer configured to include at least one of a digital circuit and an analog circuit as a processor. In particular, the digital circuit is at least one type of, for example, an ASIC (Application Specific Integrated Circuit), a FPGA (Field Programmable Gate Array), an SOC (System on a Chip), a PGA (Programmable Gate Array), a CPLD (Complex Programmable Logic Device), and the like. Such a digital circuit may include a memory in which a program is stored.

The control device may be a set of computer resources linked by a computer or a data communication device. For example, some of the functions provided by the control device in the above-described embodiment may be realized by another ECU.

The controllers and methods described in the present disclosure may be implemented by a special purpose computer created by configuring a memory and a processor programmed to execute one or more particular functions embodied in computer programs. Alternatively, the controllers and methods described in the present disclosure may be implemented by a special purpose computer created by configuring a processor provided by one or more special purpose hardware logic circuits. Alternatively, the controllers and methods described in the present disclosure may be implemented by one or more special purpose computers created by configuring a combination of a memory and a processor programmed to execute one or more particular functions and a processor provided by one or more hardware logic circuits. The computer programs may be stored, as instructions being executed by a computer, in a tangible non-transitory computer-readable medium.

It is noted that a flowchart or the processing of the flowchart in the present application includes sections (also referred to as steps), each of which is represented, for instance, as S10. Further, each section can be divided into several sub-sections while several sections can be combined into a single section. Furthermore, each of thus configured sections can be also referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A control device for controlling an application that operates based on a detection result relating to an event in an environment outside a vehicle, the control device comprising a processor, wherein:
the processor is configured to execute:
acquiring sensor information as the detection result of an autonomous sensor mounted on the vehicle;
acquiring communication information as the detection result received from an external device of the vehicle;
evaluating a detection quality of the sensor information and a detection quality of the communication information; and
changing an operation mode of the application according to the detection quality of the sensor information and the detection quality of the communication information.

2. The control device according to claim 1, wherein:
the detection quality includes at least one of: a response margin indicating a magnitude of a distance from the vehicle to the event; a freshness indicating a newness of the detection result; and an accuracy indicating a certainty of the detection result.

3. The control device according to claim 2, wherein:
the changing of the operation mode includes determining the operation mode based on the detection quality of the communication information without depending on the detection quality of the sensor information when the response margin of the communication information is disposed within an allowable margin range.

4. The control device according to claim 3, wherein:
the changing of the operation mode includes determining the operation mode without utilizing the communication information when the response margin of the communication information is disposed within the allowable margin range and the freshness of the communication information is disposed outside an allowable freshness range.

5. The control device according to claim 3, wherein:
the changing of the operation mode includes preparing to recognize the environment outside the vehicle by the autonomous sensor in a future when the response margin of the communication information is disposed within the allowable margin range and the freshness of the communication information is disposed within an allowable freshness range.

6. The control device according to claim 2, wherein:
the changing of the operation mode includes preliminarily preparing to execute a function in the application when the response margin of the communication information is disposed within an allowable margin range, the freshness of the communication information is disposed within an allowable freshness range, and the accuracy of the communication information is disposed within an allowable accuracy range.

7. The control device according to claim 2, wherein:
the changing of the operation mode includes stopping utilizing at least one of the communication information and the sensor information having the accuracy disposed outside an allowable accuracy range when the response margin of the communication information is disposed outside an allowable margin range.

8. The control device according to claim 2, wherein:
the changing of the operation mode includes preliminarily preparing to execute a function in the application when the response margin of the communication information is disposed outside an allowable margin range, the accuracy of the communication information cannot be evaluated, and the accuracy of the sensor information is disposed outside an allowable accuracy range.

9. The control device according to claim 2, wherein:
the changing of the operation mode includes stopping utilizing the communication information when the response margin of the communication information is disposed outside an allowable margin range, the accuracy of the sensor information cannot be evaluated, and the accuracy of the communication information is disposed outside an allowable accuracy range.

10. The control device according to claim 1, wherein:
the changing of the operation mode includes determining the operation mode according to whether each of the communication information and the sensor information is static information that is not changed over time, or dynamic information that is changed over time.

11. A control method executed by a processor for controlling an application that operates based on a detection result relating to an event in an environment outside a vehicle, the control method comprising:
acquiring sensor information as the detection result of an autonomous sensor mounted on the vehicle;
acquiring communication information as the detection result received from an external device of the vehicle;
evaluating a detection quality of the sensor information and a detection quality of the communication information; and
changing an operation mode of the application according to the detection quality of the sensor information and the detection quality of the communication information.

12. A non-transitory tangible computer readable storage medium comprising instructions being executed by a processor to control an application that operates based on a detection result relating to an event in an environment outside a vehicle, wherein:
the instructions includes:
acquiring sensor information as the detection result of an autonomous sensor mounted on the vehicle;
acquiring communication information as the detection result received from an external device of the vehicle;
evaluating a detection quality of the sensor information and a detection quality of the communication information; and
changing an operation mode of the application according to the detection quality of the sensor information and the detection quality of the communication information.
